(19) United States
(12) Patent Application Publication
(10) Pub. No.: US 2009/0006439 A1
(43) Pub. Date: Jan. 1, 2009

(54) SMART, SECURED REMOTE PATIENT REGISTRATION WORKFLOW SYSTEMS AND METHODS USING A KIOSK MODEL

(75) Inventors: Hencil Peter Joseph, Tamil Nadu (IN); Ramkumar Saptharishi, Bangalore (IN)

Correspondence Address: MCANDREWS HELD & MALLOY, LTD, 500 WEST MADISON STREET, SUITE 3400, CHICAGO, IL, 60661, US

(73) Assignee: GENERAL ELECTRIC COMPANY, Schenectady, NY (US)

(21) Appl. No.: 11/768,392

(22) Filed: Jun. 26, 2007

(51) Int. Cl. G06F 7/00

(52) U.S. Cl. 707/102; 707/E17.045

(57) ABSTRACT

Certain embodiments provide systems and methods for remote patient registration. A method includes configuring a kiosk in response to a user language selection; gathering data, including biometric data, from a user at the kiosk; comparing gathered data with stored patient data; and generating identification output for the user. A remote patient registration kiosk system includes keys and indicators arranged for actuation by a user. One or more of the keys and indicators is capable of being programmed to represent and to visually indicate a predetermined data or function in response to a language selection. A processor coupled to the keys and indicators programs the keys and indicators and accepts user input through actuation of the keys and indicators to register a patient based on input received from user actuation of the plurality of keys and indicators. An identification output is generated for the user in response to patient registration.

### BACKGROUND OF THE INVENTION

The present invention generally relates to remote patient registration. More specifically, the present invention relates to use of a patient kiosk for secure remote patient registration.

In the growing healthcare domain, it is desirable to have devices that can allow a user to communicate effectively with a doctor or a hospital environment irrespective of language and region. Healthcare facilities in rural areas need to be developed for improving the health status of people in developing or developed countries. Improvement in the healthcare domain can be achieved by making the medical facilities available to rural areas as well. However, there are certain limitations in the widespread use of the medical facilities in rural areas. One of the significant limitations is illiteracy or the non-knowledge of a common language like English.

In a healthcare domain, it is desirable for a patient to communicate effectively with the doctor or any other caretaker, who might be located at different parts of a country or region. Normally different people from different region will speak different languages. As the people in the rural areas or people residing in different parts of the country may not be able to understand the language of communication of the doctor, establishing effective communication between the caller and the doctor, nurse or any other care taker will be difficult. Further in case of emergency the doctor should be conveyed correctly about the severity or urgency of the situation. Most of the time communication is not carried out effectively mainly due to different languages of interaction.

Currently, patient registration involves a patient visiting a hospital or clinic and providing personal information for registration. Kiosks and other workstations allow a patient to check-in to a hospital or clinic instead of going to a front-desk staff member employed by the hospital or clinic. However, prior solutions to automate check-in have used Health Level Seven (HL7) interfaces and a third party interface engine to keep the kiosk and hospital or clinic information system updated. Interface transmissions conform to the limitations of HL7 record definitions to pass information between the kiosk and the information system. Language options are preset and not configurable. Additionally, communication between the kiosk and the information system have not occurred in real-time. Requests from the kiosk suffered from a lag inherent in the interface engine when processing the kiosk requests. Furthermore, if the interface engine were down or otherwise unavailable, then the kiosk would not work.

### BRIEF SUMMARY OF THE INVENTION

Certain embodiments of the present invention provide systems and methods for use of a patient kiosk for secure remote patient registration.

Certain embodiments provide a method for adaptive remote patient registration using a kiosk system. The method includes configuring a kiosk in response to a user selection of a language for use at the kiosk. The method also includes gathering data from a user for patient registration at the kiosk, wherein the data includes biometric data for the user. The method further includes comparing gathered data with stored patient data and generating identification output for the user.

Certain embodiments provide a method for configuration of a remote patient registration kiosk. The method includes selecting a language for input and display of patient information at the remote patient registration kiosk. Additionally, the method includes configuring at least a selected plurality of keys and indicators at the remote patient registration kiosk based on the selected language. Furthermore, the method includes associating at least one of a function and data with each of the at least a selected plurality of keys and indicators based on the selected language. The method also includes processing input for patient registration based on use of the at least a selected plurality of keys and indicators and generating patient registration output.

Certain embodiments provide a remote patient registration kiosk system. The system includes a plurality of keys and indicators arranged for actuation by a user at the kiosk system. One or more of the plurality of keys and indicators is capable of being programmed to represent a predetermined data or perform a predetermined function in response to a language selection. One or more of the plurality of keys and indicators is also capable of visually indicating a predetermined data or function based on the language selection. The system further includes a processor coupled to the plurality of keys and indicators to program the plurality of keys and indicators and to accept user input through actuation of the plurality of keys and indicators. The processor communicates with a clinical administration system to register a patient based on input received from user actuation of the plurality of keys and indicators. The system also includes an output device generating an identification output for the user in response to patient registration.

### BRIEF DESCRIPTION OF SEVERAL VIEWS OF THE DRAWINGS

FIG. 1 illustrates a healthcare administration system used in accordance with an embodiment of the present invention.

FIG. 2 illustrates an exemplary patient registration kiosk configured in accordance with an embodiment of the present invention.

FIG. 3 illustrates a kiosk device including a keypad with a plurality of keys and indicators in accordance with an embodiment of the present invention.

FIG. 4 illustrates a flow diagram for a method for configuration in a healthcare domain of a registration kiosk with a language dependent keypad as described in certain embodiments of the present invention.

FIG. 5 illustrates a flow diagram for a method for secure remote patient registration using a kiosk in accordance with an embodiment of the present invention.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF THE INVENTION

Certain embodiments of the present invention provide for systems and methods for providing medical practice and patient management. Certain embodiments utilize a kiosk model to enable remote patient registration. Use of remote patient registration via a kiosk helps to remedy problems existing with current manual registration systems. For example, a kiosk registration system may be placed in remote places covering rural areas and can also be placed inside hospitals and/or other healthcare facilities. Kiosks may provide registration services in a variety of languages. Kiosks may be securely connected to specific facilities/networks and may be managed by either individual facilities or third party service providers via secured connectivity, for example.

In certain embodiments, an e-ink enabled keypad, described further below, may be incorporated in the kiosk system to help make the system language independent. Using e-ink, people may operate the registration system in a variety of languages.

In certain embodiments, a registration kiosk system includes software configurable workflow to enable a preferred keypad language to input registration data using e-ink technology. The system also includes a fingerprint capturing display system and iris and/or other biometric capture, for example. The system also includes a capability to print or otherwise output barcode data to identify a patient by generating unique code to be used as an alternate mechanism if problems occur with biometric identification on the part of the patient and/or the system. Furthermore, the system provides a capability to print a smart card and/or other portable electronic medium. The system may also provide an ability to send the barcode information to the patient's e-mail and/or mobile phone number, for example.

In operation, for example, when a new patient wishes to register, he/she selects his/her language from a menu at a registration kiosk. An e-ink enabled keypad at the kiosk is automatically configured for the selected language. A menu presented to the user includes a form used to input basic patient data, including an e-mail address and mobile phone number. Additionally, the kiosk acquires biometric data, such as fingerprint and iris print data, for the patient, and compares the acquired data with saved biometric data, such as saved fingerprint and iris print data, existing in a database, such as a centralized database, for the facility. If the acquired data does not match the stored data, the kiosk system concludes that a registration for a new patient is being requested. Then, the kiosk system collects registration information from the patient and updates the database with this information. In certain embodiments, security for the data transfer is accounted for by the particular healthcare facility and/or a common security engine, for example. As a confirmation of successful registration, the kiosk generates a unique barcode for the patient and sends the barcode to patient through e-mail and/or mobile message. In certain embodiments, by default and/or upon patient request, the kiosk system generates a smart card or other portable electronic medium for his/her further use.

After initial registration when a patient visits a participating healthcare facility, he/she can be fingerprinted for identification and subsequently meet a doctor and/or other practitioner. In case the patient meets with an accident or loses his/her finger, iris, etc., the barcode and/or smart card may be used as an alternative form of identification.

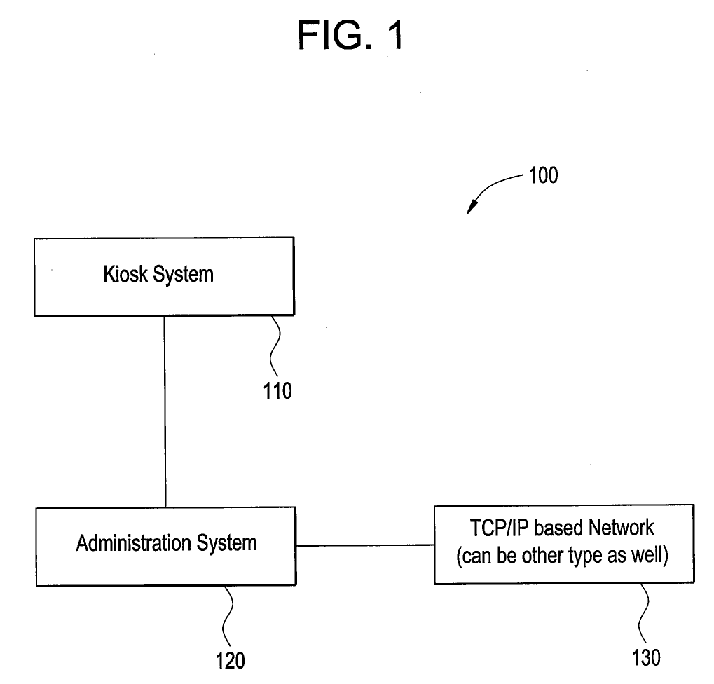

FIG. 1 illustrates a healthcare administration system 100 used in accordance with an embodiment of the present invention. The system 100 includes a kiosk system 110, an administration system 120, and a database 130. In certain embodiments, the system 100 may include other components, such as additional kiosks, additional systems (e.g., additional healthcare or clinical information systems), additional networks, etc.

The components and/or functionality of system 100 may be implemented alone or in combination in hardware, firmware, and/or as a set of instructions in software, for example. Certain embodiments may be provided as a set of instructions residing on a computer-readable medium, such as a memory, CD, DVD, or hard disk, for execution on a computer or other processing device.

The kiosk system 110 may include a self-service user kiosk, such as a Galvanon kiosk, for example. The kiosk system 110 may be implemented as a freestanding station, a computer terminal or workstation, a wireless handheld device, a Web-based or Internet-driven application and/or software on another computing device, for example.

The kiosk system 110 allows patients to check-in, register, and/or be admitted to a healthcare facility electronically without necessarily interacting with a nurse or clerk. For example, patients may be checked in for hospital stays, lab visits, and/or physician office appointments by swiping, scanning or otherwise entering a membership card, credit card, or driver's license at the kiosk system 110. Alternatively and/or in addition, patient identification may be facilitated using thumbprint or other biometric identification and/or electronic signature, for example.

Consent and HIPAA (“Health Insurance Portability and Accountability Act”) forms, for example, may be completed electronically by a patient via the kiosk system 110. Additional information, such as demographic information, medical history information and medical complaint/symptom information, may be entered electronically. Thus, for example, information may be recorded with improved accuracy and patient check-in/registration may be streamlined. Patient co-pay and/or other billing may also be facilitated via the kiosk system 110. A credit card or account balance may be used to pay at the kiosk system 110. Additionally, a patient may view and pay outstanding balances via the kiosk system 110. Furthermore, the kiosk system 110 may be used to provide information regarding directions, maps and/or other information to a patient.

The kiosk system 110 integrates with a healthcare information system and/or practice management system, such as the administration system 120 and database 130, for patient registration, check-in, information transfer/storage and/or provision of other services, for example.

The system 120 may include a healthcare information system, such as the GE/IDX Flowcast® system. The administration system 120 provides capabilities to improve revenue cycle management and data integrity, for example. Clinical and billing information may be input and shared across a clinical enterprise. Regulatory compliance is also improved through data maintenance and sharing. The system 120 may implement a “best practices” workflow to help ensure improved data capture from patients, clinicians and other users. Predetermined workflows may be provided via the system 120 to streamline patient, clinician and other employee activity. Claim and eligibility data may be entered and automatically verified to reduce claim denial. Additionally, the system 120 provides improved and simplified access to and management of patient data by clinicians and other employees. The system 120 may provide electronic medical records support to capture and access patient medical data. In certain embodiments, the system 120 may include one or more subsystems and/or applications including an order entry system, a results review system, a patient information system, a clinical decision support system, a configuration management system, a medication management system, a clinical information viewer, an allergy/problems database, a printing/reporting module, security, patient privacy protection, clinical scheduling, personal calendar, electronic mail, electronic messaging or “chat”, and/or medical resources, for example.

In certain embodiments, the system 120 may be used to facilitate access management through functional features such as a master patient index, enterprise-wide scheduling, patient visit management, eligibility verification, referrals and authorization, online tools for patients and referring physicians, and advance beneficiary notice and ambulatory payment classifications. For example, visit information is shared between hospital and physician environments, to help ensure accurate and complete information across the entire revenue cycle. Flexible admission/discharge/transfer (ADT) functions and an online bed board may help to enable proactive capacity control and bed management.

In certain embodiments, the system 120 may provide several financial capabilities to clinicians, other employees and patient. Organizations can leverage the benefits of the administrative and financial system 120 in one setting and/or across the enterprise. Built-in payer rules may help to ensure that patient information is collected correctly and completely before care is provided. Automatic charge capture cuts costs by reducing staff needed to process data manually. Additionally, claims rejections, re-work and lost charges may be reduced, maximizing reimbursement. Electronic claims, claims status checks and remittances drive more efficient overall processing and decrease time to payment. Charges may be automatically checked for accuracy prior to submission for cleaner claims, fewer rejections and less effort to correct and re-bill denials. Workflow tools may be provided to automate and streamline claims management and production to accelerate reimbursement and maximize staff productivity. Simplified, patient-friendly statements may help to reduce patient calls and improve patient satisfaction.

The system 120 may be integrated with the data storage 130 and/or may communicate with the data storage 130 to store and retrieve information.

In certain embodiments, the system 120 and kiosk 110 help enable organizations to establish a combined business office to tie together multiple hospitals or clinics and/or link physician and hospital settings to help improve efficiency, enhance patient satisfaction and increase cash flow enterprise-wide. The system 120 may streamline workflow, for example, by presenting a consolidated view of all clinical and professional financial data for a patient, guarantor or clinical encounter. Charges may be combined for both hospital/clinic and professional services on a single statement, for example.

The system 120 may also provide flexible, interactive reporting and analysis capabilities for clinicians and patients. For example, data may be stored in a relational database for querying and reporting. Analytical processing tools may be provided to review information from multiple points of view.

Additionally, certain embodiments of the system 120 may provide automated task management, electronic work lists and built-in intelligence to help eliminate unnecessary manual tasks. System alerts and reminders may be used to notify staff of outstanding tasks and automatically prioritize critical issues. In certain embodiments, documents may be captured across multiple business processes and integrated directly into the workflow.

Certain embodiments of the present invention enable self-registration for patients via a kiosk, and allow a healthcare provider's staff to have access to accurate and up-to-date patient information. Patient information includes, for example, patient name, address, social security, health insurance type, and other related health insurance information, such as a scanned image of the patient's health insurance card. In certain embodiments, the scanned image of the insurance card is date stamped to allow for timeliness of the image to be assessed in relation to the service date.

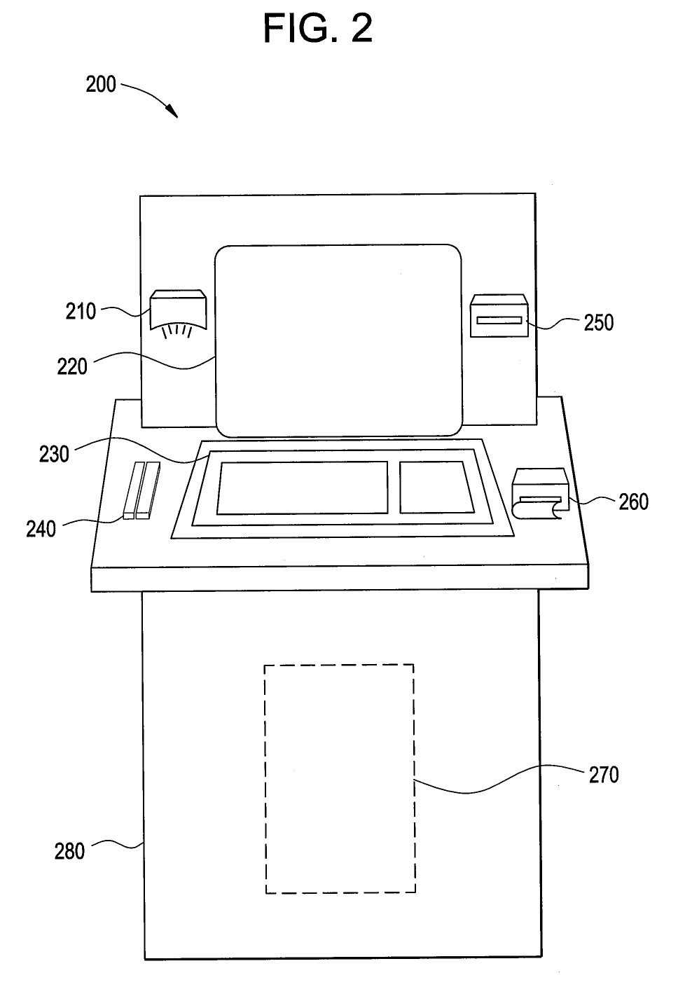

FIG. 2 illustrates an exemplary patient registration kiosk 200 configured in accordance with an embodiment of the present invention. The kiosk 200 includes a barcode reader 210, a touch screen or monitor 220, a keyboard/mouse 230, a card reader 240, a card scanner 250, an output 260, and a local processing system 270 located inside the kiosk body 280.

The registration process is driven by a number of on-screen prompts and the corresponding patient reply. In certain embodiments, a patient may select from a plurality of available languages in which to complete the registration process. In certain embodiments, new patient registration involves presentation and scanning of a plurality of information, such as a patient identification card and a patient insurance card, and/or through presentation and scanning of a single card, such as a smart card. A card can be configured with a barcode or a magnetic strip that stores information. Alternatively and/or in addition, the card can include a built-in processor to store and process data. In certain embodiments, the card is both readable and writable. As such, the card reader 240 may also be capable of writing data to the card, for example.

Output 260 may include a receipt, smartcard or other electronic medium, a printed barcode, etc. Output 260 may include a transmitter for electronic transmission of information to a patient mobile phone, e-mail, etc.

As discussed above, the kiosk may include a touch screen 220, keyboard and/or mouse 230, etc. In certain embodiments, the kiosk may include or more secondary user interfaces, such as a Braille interface, audio interface, and/or voice recognition capability, for example.

For registration, a patient scans a hospital identification card and/or other identification. If the patient is already registered and is checking in, scanning of the card triggers a request for retrieval of the corresponding patient information currently on record, including the patient's name, address, and other pertinent information, such as date of birth and social security number. The request is processed by an external server in communication with the kiosk 200, and information is sent to the requesting kiosk 200 so that it can be displayed or otherwise communicated to the patient, for example. If the patient has not previously registered, the patient may be prompted to enter his/her name and/or other identifying information (e.g., social security number) to initiate the registration and/or retrieval process.

In certain embodiments, a user interface at the kiosk 200 may then provide a prompt to the patient to confirm his/her identity. A password, code and/or secret question/answer combination can be used to protect the patient's privacy, for example. Various other security mechanisms can be employed alternatively and/or in addition (e.g., biometrics such as fingerprint or eye scan).

In certain embodiments, once identity is confirmed, the retrieved information is provided for patient review. The patient may be asked to confirm the accuracy of the retrieved information and may then be given an opportunity to edit (e.g., add, delete, modify) the information.

In certain embodiments, particular eligibility, such as eligibility for specific services, can also be determined at the kiosk 200. Eligibility may be automatically confirmed based on database information and rules and/or referred to an insurance company or clearing house for approval.

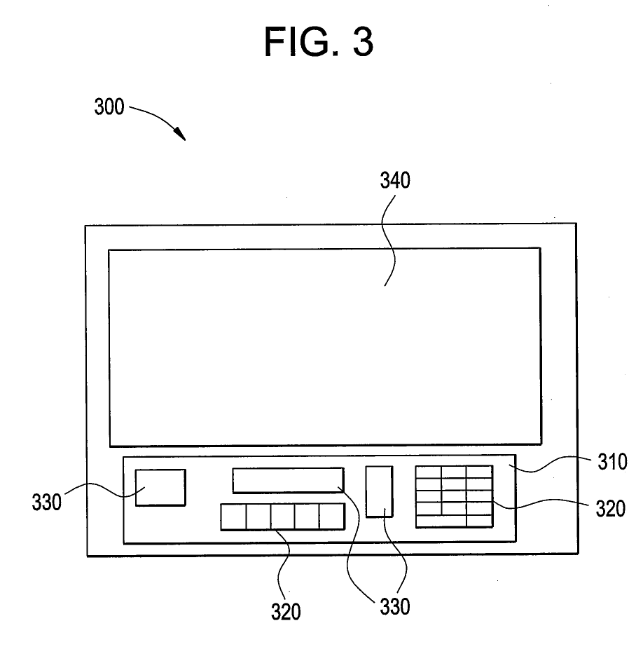

FIG. 3 illustrates a kiosk device 300 including a keypad 310 with plurality of keys 320 and indicators 330 representing an indicia of the function being carried out or data being represented. A display 340 provides information to a user in the form of information, requests for information, feedback, etc. Each key 320 or indicator 330 of the keypad 310 is capable of being programmed to perform a specific function or to represent a predetermined data. The function may be preformed by manually actuating the keys 320 of the kiosk device 300. A processor (not shown) is provided for programming a selected plurality of keys 320 and/or indicators 330 to perform a specific function or to represent a predetermined data. In an embodiment, each of the plurality of selected keys 320 and/or indicators 330 are provided with one or more indicia. The indicia provide the selected plurality of keys 320 and/or indicators 330 with a visually perceptible indicium indicative of the item of data or function represented by the keys 320 and/or indicators 330 and a visually perceptible indicium for the nature of each of the indicators. The indicia is configured to establish a visually perceptible indicia in a form for use in a given language or in the form of icons, images and/or pictures, for example. In certain embodiments, the indicia is electrically operable and maintains the indicia in visibly perceptible form even when the electrical power is off.

In an embodiment, the indicia is configured for altering indicia for the selected plurality of keys 320 and/or indicators 330. The visual indicia or appearance of the selected keys/indicators may be altered from a form suitable for use in one language to a form suitable for use in another language, making the system language independent. In another embodiment, the indicia of selected keys/indicators are altered by selecting icons, images and/or pictures indicating nature of a predetermined item of data represented or a predefined function of a key/indicator. Indicia may include an alpha-numeric character or characters, other character or characters, or icons, pictures or images. Indicia are applied to the selected keys/indicators of the kiosk 300, individually or as a whole. In an embodiment, indicia are applied as a membrane and are provided proximate to the indicators 330 or keys 320.

For example if the registration kiosk is used by a person who speaks Chinese, then the user may configure the keypad in a Chinese language by altering the indicia of the keys. If the person is illiterate, the kiosk may be configured using standard icons, pictures or images, which will visually indicate the function or data represented by the keys so that by actuating the keys representing the standard symbols or images, the user may communicate effectively without the knowledge of any language.

In an embodiment the indicia includes electronic-ink or e-ink. The electronic ink indicia includes an electronic ink film, for example. The electronic ink film is placed on the selected keys. The electronic ink film covers a plurality of said keys fully or partially. The electronic ink film is placed in proximity to the keys or indicators.

A processor is coupled to the keypad for programming a plurality of selected keys to perform a specific function or to represent a predetermined data. The processor further includes a memory for storing alpha-numeric characters or characters corresponding to a predefined set of languages and icons, images or pictures indicating the nature of a predetermined item of data represented or a predefined function key, for example.

In an embodiment, the kiosk is synchronized with an external system, such as an electronic medical record system and/or other clinical information system, for example. Synchronization may occur via a software loaded on the kiosk and the external system, for example. This software may be loaded to the memory associated with the processor, for example. In an embodiment, the kiosk may be connected to an external system via wireless, wired and/or other connection, for example.

In an embodiment, the keys are provided in the form of switches mounted on a substrate of a printed circuit board. In an embodiment, the indicia may be represented via Liquid Crystal Displays (LCDs), for example.

In an embodiment, keys may indicate kiosk status, for example. In another embodiment, the kiosk keypad can include different programmable/configurable “severity indices” configured to indicate or represent the severity of a situation/patient. Indicators may be provided by configuring the visual indicia of the labels affixed near to the indicators to display the nature of the indicators. Alternately and/or in addition, the indicators may be configured to display or send different colors to indicate the severity. The severity may be conveyed visually or aurally. The severity may be conveyed with the help of actuating a predefined key, which may be programmed to send an alert signal upon activation. In an example, the key may be visually represented as “Alarm Key” using an indicia. The kiosk may be configured to have a default severity, if no severity was selected. In certain embodiments, a user may be given flexibility to set the severity based on need.

Using e-ink, a flexible electronic ink film is applied over the keys to provide indicia for each of the keys. An electronic ink film may similarly be applied adjacent to non-key indicators. Electronic ink film may be covered by a flexible protection layer, if desired, to lend durability and a longer service life to keyboard.

In certain embodiments, the electronics ink film utilizes thin film transistor (TFT) technology in which plastic transistors are printed on to a thin film of plastic for use in controlling a layer of pigmented microcapsules that are changed from a first color to a second color and back by using small electrical charges controlled by the plastic transistors. For example, an electronic ink microcapsule may be sandwiched between two layers of thin film transistors that are charged with a positive or negative polarity, respectively. The microcapsule may be filled with a blue or similarly colored ink, for example, within which white, electronically charged, balls, chips, or similar elements are suspended.

In this example, negatively charged balls react to the charges of thin film transistors. The first thin film transistor layer has a positive charge that attracts the white balls to the top of microcapsule, thus making it appear white when viewed from the top. Conversely, the second thin film transistor layer has a positive charge, and the white balls are attracted towards the second thin film transistor layer, thus exposing the blue ink, for example. This makes the microcapsule appear blue when viewed from the top. By employing a plurality of the microcapsules in the layer, as operated by the thin film transistor layers, indicia for the keys and indicators may be formed from the microcapsules contained in film. Thin film transistor layers can be operated by conductors in a printed circuit board, for example.

Advantages of electronic ink technology include high contrast, a wide viewing angle, and legibility in low light. Indicia formed from electronic ink consume no power except when the indicia are being changed and allow the indicia to remain in a visually perceptible form when the power is turned off.

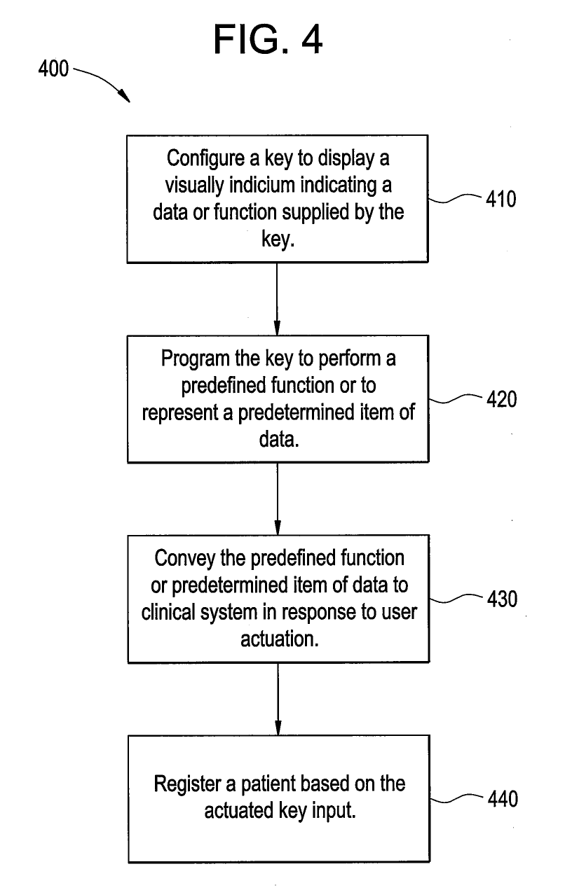

FIG. 4 depicts a flow diagram for a method 400 for configuration in a healthcare domain of a registration kiosk with a language independent keypad as described in certain embodiments of the present invention. At step 410, at least a selected plurality of keys in the keypad is configured to display a visually perceptible indicium for each of the selected keys indicative of an item of data or function represented by the keys. Indicia may be altered for the selected plurality of keys and/or indicators from a form suitable for use in one language to a form suitable for use in another language and/or to select images or pictures indicating nature of a predetermined item of data represented or a predefined function of a key, for example. At step the 420, at least one key is programmed for performing a predefined function or to represent a predetermined item of data. A processor is provided for programming the keys and changing the indicia, for example. At step 430, the predefined function or predetermined item of data is conveyed to a clinical information system by actuating the keys representing corresponding indicium. The visual indicium of the keys may be in the language known to the user or may be represented by standard icons, images or pictures. Thus if a key is programmed to call up the hospital by actuating that key the user may call up the doctor directly. The key visually represents the “+” symbol to call the doctor. Similarly different keys, which are pre-programmed to perform different functions or to represent predetermined data may be actuated for carrying different functions. In an example, a key may be stored with some data, and the actuating the key will transmit that data as part of a patient registration to a hospital/clinic information system. In emergency the user need not have to call up the doctor or to send an SMS, instead he may actuate the key programmed for sending an SMS to the doctor. At step 440, patient registration is completed based on the actuated key(s) through a server or other computer system associated with the clinical environment. The server is fed with the patient information to provide barcode, smart card and/or other registration, for example.

One or more of the steps of the method 400 may be implemented alone or in combination in hardware, firmware, and/or as a set of instructions in software, for example. Certain embodiments may be provided as a set of instructions residing on a computer-readable medium, such as a memory, hard disk, DVD, or CD, for execution on a general purpose computer or other processing device.

Certain embodiments of the present invention may omit one or more of these steps and/or perform the steps in a different order than the order listed. For example, some steps may not be performed in certain embodiments of the present invention. As a further example, certain steps may be performed in a different temporal order, including simultaneously, than listed above.

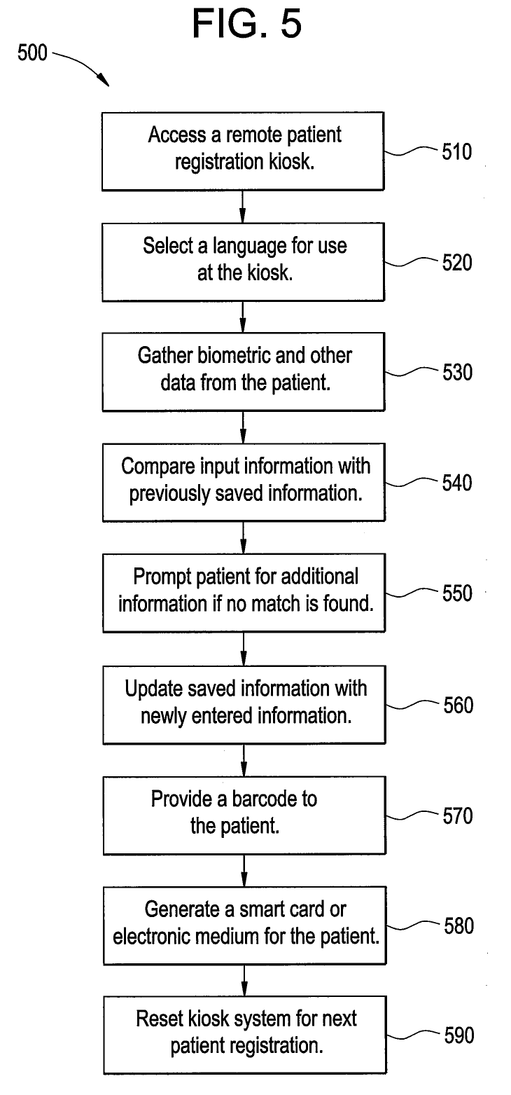

FIG. 5 illustrates a flow diagram for a method 500 for secure remote patient registration using a kiosk in accordance with an embodiment of the present invention. At step 5 10, a patient accesses a remote patient registration kiosk. At step 520, a patient selects a language for use at the kiosk. For example, a patient may select a language in which to configure keys and other indicators at the kiosk using e-ink or other display technology. Thus, questions regarding patient data, inputs for patient data, and output may be displayed in the patient's selected language rather than being in a single common format.

At step 530, biometric data is gathered from the patient. For example, one or more scanners at the kiosk may be used to gather finger print, iris print, and/or other biometric information for the patient. At step 540, the kiosk system compares the input information with information existing in a registration database. For example, the system compares scanned finger print and iris print data with data stored in a centralized patient database. At step 550, if no match is found, the kiosk prompts the patient for further information to complete registration. For example, the patient may be asked for address, insurance, history, and/or other information to complete registration. If a match is found, the patient may not be prompted to enter any further information. However, even a registered patient may be prompted to enter a malady, symptom(s), emergency, and/or other reason for a visit or request for medical attention.

At step 560, the kiosk system updates the database with entered information, and, if the patient is new, a barcode is generated for the patient. For example, a new patient registration may be completed based on patient information submitted at step 550 above. Existing patients may already have an assigned barcode, and/or a new barcode may be generated/updated for updated patient information and/or a particular patient visit.

At step 570, the barcode is provided to the patient. The barcode may be printed at the kiosk, transmitted to the patient via email, transmitted to the patient via mobile phone, transmitted to the patient via facsimile, etc. In certain embodiments, at step 580, a smart card and/or other electronic medium may be generated for the patient including patient registration and/or other patient information. The barcode and/or smart card may be used by the patient as identification for access and/or transmission of information for a clinical encounter. In certain embodiments, electronic medical record information and/or other patient data may be provided via the barcode and/or smart card, for example.

At step 590, the kiosk system is reset for a next patient registration.

One or more of the steps of the method 500 may be implemented alone or in combination in hardware, firmware, and/or as a set of instructions in software, for example. Certain embodiments may be provided as a set of instructions residing on a computer-readable medium, such as a memory, hard disk, DVD, or CD, for execution on a general purpose computer or other processing device.

Certain embodiments of the present invention may omit one or more of these steps and/or perform the steps in a different order than the order listed. For example, some steps may not be performed in certain embodiments of the present invention. As a further example, certain steps may be performed in a different temporal order, including simultaneously, than listed above.

Thus, certain embodiments have a technical effect of communicating language independently in a healthcare domain. The language independency will allow the flexibility of connecting the rural population to a hospital in the urban area without actually knowing the language prevalent in the urban area.

In certain embodiments, no human resources are required for registering patients. A kiosk registration system can be placed not only in hospitals, doctor's offices or clinics, but also in any common place, so that registration is possible from any convenient location. Patients can save their time by avoiding queues or hospital visits that were only for the purpose of registration. Additionally, offering a combination of fingerprint, e-ink, barcode, and smart card facilities add more value to the patient registration process.

A kiosk-based workflow concept for remote patient registration provides a workflow involving the usage of an e-ink enabled kiosk model system, for example. An e-ink registration system helps enable language independence and collection of patient's fingerprint and iris print for dual-level identification of a patient. In certain embodiments, the kiosk system includes a capability to generate biometric, barcode and smart card printing service from the kiosk.

Several embodiments are described above with reference to drawings. These drawings illustrate certain details of specific embodiments that implement the systems and methods and programs of the present invention. However, describing the invention with drawings should not be construed as imposing on the invention any limitations associated with features shown in the drawings. The present invention contemplates methods, systems and program products on any machine-readable media for accomplishing its operations. As noted above, the embodiments of the present invention may be implemented using an existing computer processor, or by a special purpose computer processor incorporated for this or another purpose or by a hardwired system.

As noted above, embodiments within the scope of the present invention include program products comprising machine-readable media for carrying or having machine-executable instructions or data structures stored thereon. Such machine-readable media can be any available media that can be accessed by a general purpose or special purpose computer or other machine with a processor. By way of example, such machine-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such a connection is properly termed a machine-readable medium. Combinations of the above are also included within the scope of machine-readable media. Machine-executable instructions comprise, for example, instructions and data which cause a general purpose computer, special purpose computer, or special purpose processing machines to perform a certain function or group of functions.

Embodiments of the invention are described in the general context of method steps which may be implemented in one embodiment by a program product including machine-executable instructions, such as program code, for example in the form of program modules executed by machines in networked environments. Generally, program modules include routines, programs, objects, components, data structures, etc., that perform particular tasks or implement particular abstract data types. Machine-executable instructions, associated data structures, and program modules represent examples of program code for executing steps of the methods disclosed herein. The particular sequence of such executable instructions or associated data structures represents examples of corresponding acts for implementing the functions described in such steps.

Embodiments of the present invention may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of the invention might include a general purpose computing device in the form of a computer, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to a removable optical disk such as a CD ROM or other optical media. The drives and their associated machine-readable media provide nonvolatile storage of machine-executable instructions, data structures, program modules and other data for the computer.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another.

1. A method for adaptive remote patient registration using a kiosk system, said method comprising:
configuring a kiosk in response to a user selection of a language for use at the kiosk;
gathering data from a user for patient registration at the kiosk, wherein the data includes biometric data for the user;
comparing gathered data with stored patient data; and
generating identification output for the user.

2. The method of claim 1, wherein the identification output comprises a barcode.

3. The method of claim 1, wherein the identification output comprises a smart card including patient registration information.

4. The method of claim 1, further comprising prompting the user for additional information if said comparing step does not find a match between the gathered data and the stored patient data, said additional information completing a patient registration for the user.

5. The method of claim 4, further comprising updating a patient database with the additional information for the user.

6. The method of claim 1, wherein said configuring step further comprises configuring keys and indicators at the kiosk with indicia, data, and function based on the language selected by the user.

7. The method of claim 6, wherein said keys and indicators are configured using at least one of electronic ink and liquid crystal displays.

8. The method of claim 1, further comprising transmitting patient information to a clinical administration system for use with respect to the user.

9. A method for configuration of a remote patient registration kiosk, said method comprising:
selecting a language for input and display of patient information at the remote patient registration kiosk;
configuring at least a selected plurality of keys and indicators at the remote patient registration kiosk based on the selected language;
associating at least one of a function and data with each of the at least a selected plurality of keys and indicators based on the selected language;
processing input for patient registration based on use of the at least a selected plurality of keys and indicators; and
generating patient registration output.

10. The method of claim 9, further comprising representing the at least a selected plurality of keys and indicators to a user at the remote patient registration kiosk based on the selected language.

11. The method of claim 10, wherein the at least a selected plurality of keys and indicators are represented using at least one of electronic ink and liquid crystal displays.

12. The method of claim 9, wherein said generating step further comprises generating a barcode representing said patient registration.

13. The method of claim 9, wherein said generating step further comprises generating a smart card representing said patient registration.

14. The method of claim 9, further comprising gathering data from a user for patient registration at the kiosk, wherein the data includes biometric data for the user.

15. A remote patient registration kiosk system, said system comprising:
a plurality of keys and indicators arranged for actuation by a user at the kiosk system, one or more of said plurality of keys and indicators capable of being programmed to represent a predetermined data or perform a predetermined function in response to a language selection, one or more of said plurality of keys and indicators capable of visually indicating a predetermined data or function based on the language selection;
a processor coupled to said plurality of keys and indicators to program the plurality of keys and indicators and accept user input through actuation of said plurality of keys and indicators, said processor communicating with a clinical administration system to register a patient based on input received from user actuation of said plurality of keys and indicators; and
an output device generating an identification output for the user in response to patient registration.

16. The remote patient registration kiosk system of claim 15, further comprising a memory for storing alphanumeric characters or characters corresponding to a predefined set of languages and icons, images or pictures indicating nature of a predetermined item of data represented or a predefined function for a key or indicator.

17. The remote patient registration kiosk system of claim 15, further comprising:
a clinical information system including patient information, practice information and services; and
a Web service configured to facilitate communication of data between said kiosk and said clinical information system via a network.

18. The remote patient registration kiosk system of claim 15, wherein said clinical administration system returns information including at least one of registration, insurance, appointment, visit and financial information to said kiosk.

19. The remote patient registration kiosk system of claim 15, wherein said processor compares data gathered from the user with stored patient data.

20. The remote patient registration kiosk system of claim 19, wherein the stored patient data is stored in a central database.

21. The remote patient registration kiosk system of claim 19, wherein the processor triggers a display to prompt the user for additional information if the comparison of data does not find a match between the gathered data and the stored patient data, said additional information completing a patient registration for the user.

22. The remote patient registration kiosk system of claim 21, further comprising updating a patient database with the additional information for the user.

23. The remote patient registration kiosk system of claim 19, wherein the gathered data includes biometric data for the user.

24. The remote patient registration kiosk system of claim 15, wherein the identification output comprises at least one of a barcode and a smart card.

25. The remote patient registration kiosk system of claim 15, wherein said keys and indicators are configured using at least one of electronic ink and liquid crystal displays.

26. The remote patient kiosk registration system of claim 15, wherein said kiosk returns updated at least one of registration, insurance, appointment, visit and financial data back to said clinical information system.
